(19) United States
(12) Patent Application Publication
(10) Pub. No.: US 2026/0356211 A1
(43) Pub. Date: Nov. 12, 2026

(54) MOTOR DRIVING APPARATUS AND ELECTRIFIED VEHICLE USING THE SAME

(71) Applicants: Hyundai Motor Company, Seoul (KR); Kia Corporation, Seoul (KR)

(72) Inventors: Tae Gyeom WOO, Hwaseong-si (KR); Jae Sang Lim, Hwaseong-si (KR); Ho Rim Choi, Hwaseong-si (KR); Jin Wook Kang, Hwaseong-si (KR); Tae Jun Moon, Hwaseong-si (KR); Tae Il Yoo, Hwaseong-si (KR); Sang Woo Park, Hwaseong-si (KR)

(73) Assignees: Hyundai Motor Company, Seoul (KR); Kia Corporation, Seoul (KR)

(21) Appl. No.: 19/393,326

(22) Filed: Nov. 18, 2025

(30) Foreign Application Priority Data
May 12, 2025 (KR) 10-2025-0061396

(51) Int. Cl. B60L 15/20; B60L 15/08; H02P 27/08

(52) U.S. Cl. CPC B60L 15/2045; B60L 15/08; H02P 27/08; B60L 2210/42; B60L 2240/421; B60L 2240/423; B60L 2240/429; B60L 2240/526; H02P 2207/076

(57) ABSTRACT

A motor driving apparatus configured for efficiently driving a dual three-phase motor is designed so that a first three-phase winding and a second three-phase winding have different inductances, and an electrified vehicle using the same. The motor driving apparatus appropriately determines one of a dual three-phase mode using all two inverters of the motor or a single three-phase mode using only one of the two inverters. A controller of the motor driving apparatus generates a control signal to turn on/off an inverter according to a driving mode. In addition, the controller controls an on/off state of a circulating current controller to prevent circulating current according to the driving mode. This enables high output control and high efficiency control of the dual three-phase motor.

### CROSS-REFERENCE TO THE RELATED APPLICATION

The present application claims priority from Korean Patent Application No. 10-2025-0061396, filed on May 12, 2025, the present disclosure of which is incorporated herein by reference in its entirety.

### FIELD OF THE PRESENT DISCLOSURE

The present disclosure relates to a motor driving apparatus configured for efficiently driving a motor and an electrified vehicle using the same.

### R ELATED ART

In general, one end of each of windings of respective phases included in a motor is connected to an inverter and the other ends of the windings of the respective phases are interconnected to form a Y-connection.

When the motor is driven, a switching element inside the inverter is turned on or off by pulse width modulation control, applying line voltage to the Y-connected windings of the motor to generate alternating current, thereby generating torque.

Fuel efficiency (or power efficiency) of an eco-friendly vehicle such as an electric vehicle that uses the torque generated by such a motor as power is determined by power conversion efficiency of the inverter-motor. Therefore, to improve fuel efficiency, it is important to maximize power conversion efficiency of the inverter and efficiency of the motor.

Efficiency of an inverter-motor system is mainly determined by a voltage utilization rate of the inverter. When an operating point of the vehicle is formed by a relationship between a motor speed and torque in a section having a high voltage utilization rate, fuel efficiency of the vehicle may be improved.

However, as the number of windings of the motor is increased to increase the maximum torque of the motor, the section having the high voltage utilization rate becomes farther away from a low torque region, which is a main operating point of the vehicle, so that a problem of poor fuel efficiency may occur. In addition, when the main operating point is designed to be included in the section having the high voltage utilization rate from the perspective of fuel efficiency, there may be a problem of poor acceleration and starting performance of the vehicle due to restrictions on the maximum torque of the motor.

In addition, in the case of a system using a three-phase permanent magnet synchronous motor, which is widely used in electrified vehicles, there are advantages of high-power density and stability while there are disadvantages of high cost in manufacturing a high-output power module for driving a high-capacity motor and difficulty in fault response operation when a motor or an inverter fails during operation.

Accordingly, in the present technical field, research has been conducted on a dual three-phase permanent magnet synchronous motor system that uses a motor including two sets of windings and two low-power power modules instead of one high-capacity motor and one high-power power module to achieve effects such as high power, high efficiency, reduced torque ripple, and reduced noise.

The matters described as background technology above are only intended to enhance understanding of the background of the present disclosure, and should not be taken as an acknowledgment that the matters correspond to the related art already known to those of ordinary skill in the art.

### BRIEF SUMMARY

Accordingly, a technical task to be solved by the present disclosure is to provide a motor driving apparatus configured for efficiently driving a dual three-phase motor and a vehicle using the same.

Technical tasks to be achieved in the present disclosure are not limited to the technical tasks mentioned above, and other technical tasks not mentioned herein will be clearly understood by a person having ordinary skill in the technical field to which the present disclosure pertains from the description below.

According to various aspects of the present disclosure, the above and other objects can be accomplished by the provision of a motor driving apparatus including a first inverter including a plurality of first switching elements and connected to a first three-phase winding of a dual three-phase motor, a second inverter including a plurality of second switching elements and connected to a second three-phase winding of the dual three-phase motor, and a controller operatively connected to the first inverter and the second inverter and configured to drive the dual three-phase motor in a dual three-phase mode or a single three-phase mode by selectively controlling the first inverter and the second inverter, wherein the first three-phase winding and the second three-phase winding have different inductances.

According to various aspects of the present disclosure, the first three-phase winding and the second three-phase winding of the dual three-phase motor may have different turn ratios.

According to various aspects of the present disclosure, the controller may include a circulating current controller configured to reduce a circulating current caused by a difference in applied voltage between the first three-phase winding and the second three-phase winding based on the dual three-phase motor being driven in the dual three-phase mode.

According to various aspects of the present disclosure, the controller may be configured to turn off the circulating current controller based on the motor being driven in the single three-phase mode, and turn on the circulating current controller based on the motor being driven in the dual three-phase mode.

According to various aspects of the present disclosure, the first three-phase winding and the second three-phase winding may have the same phase.

According to various aspects of the present disclosure, there may be a phase difference between the first three-phase winding and the second three-phase winding.

According to various aspects of the present disclosure, the controller may be configured to control the dual three-phase motor in a first single three-phase mode in which the first inverter is turned on to drive the dual three-phase motor, or a second single three-phase mode in which the second inverter is turned on to drive the dual three-phase motor based on the dual three-phase motor being driven in the single three-phase mode.

According to various aspects of the present disclosure, the controller may be configured to determine a driving mode based on a rotation speed and torque command of the dual three-phase motor.

According to various aspects of the present disclosure, there is provided an electrified vehicle including a dual three-phase motor in which a first three-phase winding and a second three-phase winding have different inductances, a first inverter including a plurality of first switching elements and connected to the first three-phase winding of the dual three-phase motor, a second inverter including a plurality of second switching elements and connected to the second three-phase winding of the dual three-phase motor, and a controller operatively connected to the first inverter and the second inverter and configured to drive the dual three-phase motor in a dual three-phase mode or a single three-phase mode by selectively controlling the first inverter and the second inverter.

According to various aspects of the present disclosure, the first three-phase winding and the second three-phase winding of the dual three-phase motor may have different turn ratios.

According to various aspects of the present disclosure, the controller may include a circulating current controller configured to reduce a circulating current caused by a difference in applied voltage between the first three-phase winding and the second three-phase winding based on the dual three-phase motor being driven in the dual three-phase mode.

According to various aspects of the present disclosure, the controller may be configured to turn off the circulating current controller based on the motor being driven in the single three-phase mode, and turn on the circulating current controller based on the motor being driven in the dual three-phase mode.

According to various aspects of the present disclosure, the first three-phase winding and the second three-phase winding may have the same phase.

According to various aspects of the present disclosure, there may be a phase difference between the first three-phase winding and the second three-phase winding.

According to various aspects of the present disclosure, the controller may be configured to control the dual three-phase motor in a first single three-phase mode in which the first inverter is turned on to drive the dual three-phase motor, or a second single three-phase mode in which the second inverter is turned on to drive the dual three-phase motor based on the dual three-phase motor being driven in the single three-phase mode.

According to various aspects of the present disclosure, the controller may be configured to determine a driving mode based on a rotation speed and torque command of the dual three-phase motor.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a circuit diagram illustrating an example of a motor driving apparatus including a battery, a plurality of inverters, a motor, and a controller configured for controlling the same according to an exemplary embodiment of the present disclosure;

FIG. 2 is a circuit diagram illustrating an equivalent circuit of a dual three-phase motor according to an exemplary embodiment of the present disclosure;

FIG. 3 is a block diagram illustrating an example of a process in which the controller configured to control the dual three-phase motor receives a torque command and various information related to the motor and generates a motor control signal according to an exemplary embodiment of the present disclosure;

FIG. 4 is a block diagram illustrating an example of a process in which a circulating current controller of a current control unit is configured to reduce a circulating current according to an exemplary embodiment of the present disclosure;

FIG. 5 is a block diagram illustrating an example of a process in which the current control unit of the controller is configured to generate the first voltage command and the second voltage command according to an exemplary embodiment of the present disclosure;

FIG. 6 is a block diagram illustrating an example of a process in which a voltage modulation unit of the controller is configured to receive a voltage command and generates a control signal according to an exemplary embodiment of the present disclosure;

FIG. 7 is a graph illustrating an example of a driving strategy of the dual three-phase motor according to an exemplary embodiment of the present disclosure; and

FIG. 8 is a flowchart illustrating an example of a process in which the controller is configured to control the circulating current controller according to a motor driving mode according to an exemplary embodiment of the present disclosure.

### DETAILED DESCRIPTION

Hereinafter, various exemplary embodiments disclosed in the present specification will be described in detail with reference to the appended drawings. However, identical or similar components will be assigned the same reference numbers regardless of reference symbols, and duplicate descriptions thereof will be omitted. The suffixes "module" and "unit" for components used in the following description are given or used interchangeably only for the ease of preparing the specification, and do not have distinct meanings or roles in themselves. Furthermore, in describing embodiments disclosed in the present specification, when it is determined that a detailed description of related publicly known technology may obscure the gist of the exemplary embodiments disclosed in the present specification, the detailed description thereof will be omitted. Furthermore, the appended drawings are only for easy understanding of the exemplary embodiments disclosed in the present specification, and the technical idea disclosed in the present specification is not limited by the appended drawings. Furthermore, it should be understood that the present disclosure encompasses all changes, equivalents, and substitutes included in the spirit and technical scope of the present disclosure.

Although terms including ordinal numbers, such as "first", "second", etc., may be used herein to describe various components, the components are not limited by these terms. These terms are generally only used to distinguish one component from another.

When a component is referred to as being "coupled" or "connected" to another component, the component may be directly coupled or connected to the other component. However, it should be understood that another component may be present therebetween. In contrast, when a component is referred to as being "directly coupled" or "directly connected" to another component, it should be understood that there are no other components therebetween.

A singular expression includes the plural form unless the context clearly dictates otherwise.

In the present specification, it should be understood that a term such as "include" or "have" is intended to designate that the features, numbers, steps, operations, components, parts, or combinations thereof described in the specification are present, and does not preclude the possibility of presence or addition of one or more other features, numbers, steps, operations, components, parts, or combinations thereof.

Furthermore, the term "unit" or "control unit" included in a name such as a motor control unit (MCU) is merely a widely used term for naming a controller that is configured to control a specific vehicle function, and does not mean a generic functional unit. For example, each controller may include a communication device that communicates with another controller or a sensor to control a function assigned thereto, a memory that stores an operating system, a logic command, input/output information, etc., and one or more processors that perform determination, calculation, decision, etc. necessary for controlling a function assigned thereto.

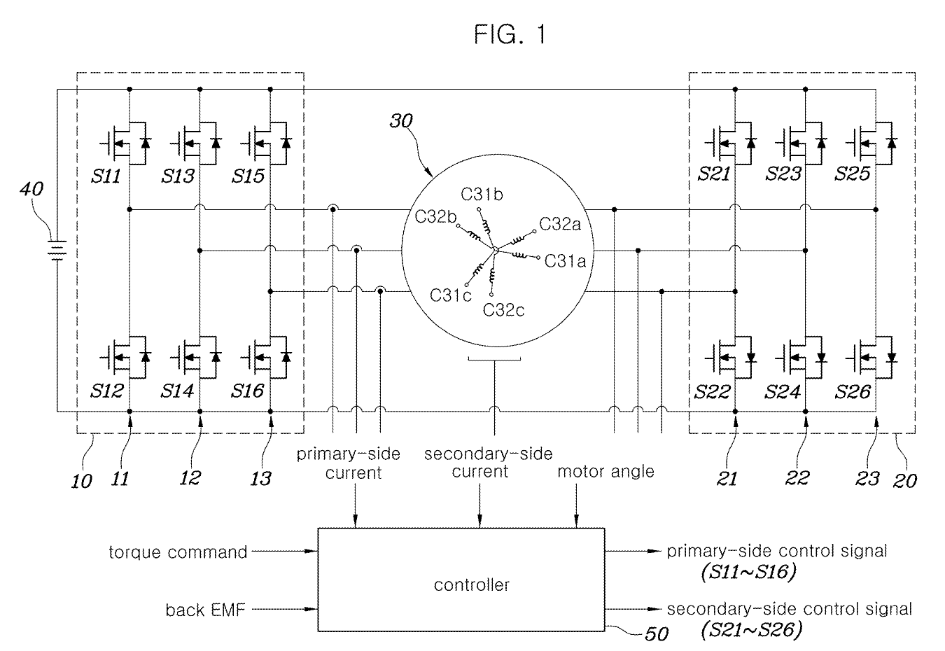

FIG. 1 is a circuit diagram illustrating an example of a motor driving apparatus including a battery, a plurality of inverters, a motor, and a controller configured for controlling the same according to an exemplary embodiment of the present disclosure.

Referring to FIG. 1, the motor driving apparatus according to the exemplary embodiment of the present disclosure may include a first inverter 10, a second inverter 20, a motor 30 having a plurality of first three-phase windings C31a, C31b, and C31c and a plurality of second three-phase windings C32a, C32b, and C32c corresponding to a plurality of phases, respectively, a battery 40, and a controller 50.

The first inverter 10 may include a plurality of first switching elements S11, S12, S13, S14, S15 and S16 connected to each of the plurality of first three-phase windings C31a, C31b, and C31c, and the second inverter 20 may include a plurality of second switching elements S21, S22, S23, S24, S25 and S26 connected to each of the plurality of second three-phase windings C32a, C32b, and C32c. The controller 50 may be configured for controlling on/off states of the first switching elements S11, S12, S13, S14, S15 and S16 and the second switching elements S21, S22, S23, S24, S25 and S26 based on a motor torque command, DC terminal voltages of the first inverter 10 and the second inverter 20 (i.e., the voltage of the battery), a phase current of the motor, and a motor angle.

The first inverter 10 may include a plurality of primary-side legs 11, 12, and 13 to which a DC voltage is applied by the battery 40. The respective legs 11, 12, and 13 may correspond to a plurality of phases of the first three-phase windings C31a, C31b, and C31c, respectively, to form electric connection.

The first leg 11 among the primary-side legs includes two switching elements S11 and S12 connected in series, and a connection node of the two switching elements S11 and S12 may be connected to the winding C31a of one phase in the motor 30 so that AC power corresponding to one of the plurality of phases may be input and output. Similarly, the second leg 12 includes two switching elements S13 and S14 connected in series, and a connection node of the two switching elements S13 and S14 may be connected to the winding C31b of one phase in the motor 30 so that AC power corresponding to one of the plurality of phases may be input and output. In addition, the third leg 13 includes two switching elements S15 and S16 connected in series, and a connection node of the two switching elements S15 and S16 may be connected to the winding C31c of one phase of the motor 30 so that AC power corresponding to one of the plurality of phases is input and output.

The second inverter 20 may include a plurality of secondary-side legs 21, 22, and 23 to which a DC voltage is applied by the battery 40. The respective legs 21, 22, and 23 may correspond to a plurality of phases of the second three-phase windings C32a, C32b, C32c, respectively, to form electric connection.

The first leg 21 among the secondary-side legs includes two switching elements S21 and S22 connected in series, and a connection node of the two switching elements S21 and S22 may be connected to the winding C32a of one phase in the motor 30 so that AC power corresponding to one of the plurality of phases may be input and output. Similarly, the second leg 22 includes two switching elements S23 and S24 connected in series, and a connection node of the two switching elements S23 and S24 may be connected to the winding C32b of one phase in the motor 30 so that AC power corresponding to one of the plurality of phases may be input and output. In addition, the third leg 23 includes two switching elements S25 and S26 connected in series, and a connection node of the two switching elements S25 and S26 may be connected to the winding C32c of one phase of the motor 30 so that AC power corresponding to one of the plurality of phases is input and output.

Although not illustrated in FIG. 1, the motor driving apparatus may further include a so-called Y-capacitor (Y-Cap) that connects two capacitors connected in series between a positive (+) DC terminal and a negative (-) DC terminal, and grounds a connection node between the capacitors.

The controller 50 may perform a control operation so that the motor 30 may be driven by switching the switching elements S11, S12, S13, S14, S15 and S16, and S21, S22, S23, S24, S25 and S26 included in the first inverter 10 and the second inverter 20 through pulse width modulation control based on a torque command required for the motor 30.

Furthermore, the controller 50 may be configured for controlling the on/off state of the first switching elements S11, S12, S13, S14, S15 and S16 and the second switching elements S21, S22, S23, S24, S25 and S26 according to a motor driving mode. The motor driving mode may include a single three-phase mode and a dual three-phase mode.

When driving the motor 30 in the single three-phase mode, the controller 50 may drive the motor 30 through only one of the two inverters 10 and 20, and when driving the motor 30 in the dual three-phase mode, the controller 50 may drive the motor 30 using both the first inverter and the second inverter.

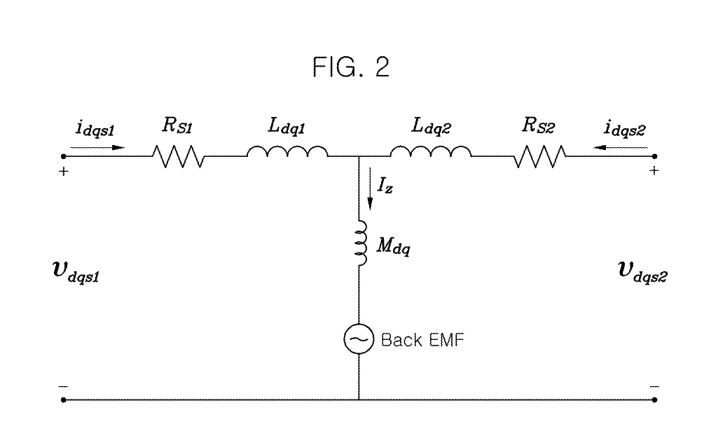

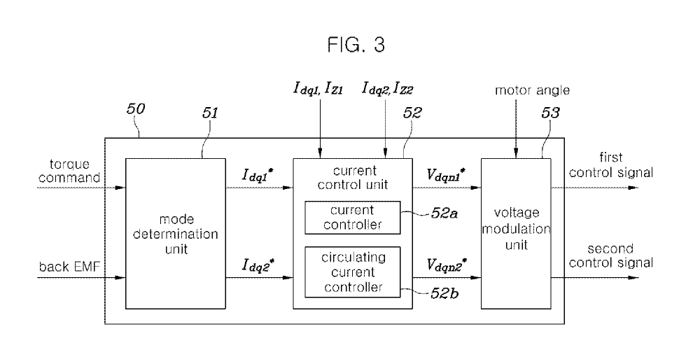

Hereinafter, structures of the motor 30 and the controller 50 will be described in more detail with reference to FIG. 2 and FIG. 3.

FIG. 2 is a circuit diagram illustrating an equivalent circuit of a dual three-phase motor according to an exemplary embodiment of the present disclosure.

FIG. 2 illustrates an equivalent circuit expressed based on results of performing synchronous coordinate system d-q transformation for each variable of the dual three-phase motor according to the exemplary embodiment of the present disclosure. In more detail, a voltage of v_{dqs1} may be applied to the first three-phase windings of the motor 30, and a voltage of v_{dqs2} may be applied to the second three-phase windings. Furthermore, the motor 30 may have an internal resistance Rₛ₁ due to the first three-phase windings and an inductance L_{dq1} of the first three-phase windings, and similarly have an internal resistance Rₛ₂ due to the second three-phase windings and an inductance L_{dq2} of the second three-phase windings. Furthermore, mutual inductance M_{dq} may be present between the first three-phase windings and the second three-phase windings.

As an example of motor design, a phase difference between the first three-phase windings and the second three-phase windings of the dual three-phase motor may be determined to be 30 degrees, and the inductance L_{dq1} of the first three-phase windings and the inductance L_{dq2} of the second three-phase windings may be designed to be the same.

In the instant case, since the mutual inductance M_{dq} between the first three-phase windings and the second three-phase windings generally has a larger value than the inductance L_{dq1} of the first three-phase windings and the inductance L_{dq2} of the second three-phase windings, voltage interference between the windings is large. Furthermore, the phase difference between the first three-phase windings and the second three-phase windings may cause power loss and a control problem due to increase in a fifth harmonic current and a seventh harmonic current when the motor is driven in a high-speed region.

On the other hand, as in an example according to an exemplary embodiment of the present disclosure, the inductance L_{dq1} of the first three-phase windings and the inductance L_{dq2} of the second three-phase windings may be designed to have different values. For example, when the first three-phase windings and the second three-phase windings are configured as the same conductor, the inductance L_{dq1} of the first three-phase windings and the inductance L_{dq2} of the second three-phase windings may have different values by setting turn ratios of the respective windings to be different. A driving strategy advantage and circulating current control by the present design will be described in detail later.

FIG. 3 is a block diagram illustrating an example of a process in which the controller configured to control the dual three-phase motor receives a torque command and various information related to the motor and generates a motor control signal according to an exemplary embodiment of the present disclosure.

Referring to FIG. 3, the controller 50 may include a mode determination unit 51, a current control unit 52, and a voltage modulation unit 53.

The mode judgment unit 51 may receive a torque command and a Back EMF(Back ElectroMotive Force) value of the motor 30 and determine a driving mode in which the motor 30 will be driven. For example, it is possible to determine whether to adopt the single three-phase mode or the dual three-phase mode for driving depending on the motor rotation speed and generate a first current command I_{dq1} ^{*} for the first three-phase windings and a second current command I_{dq2} ^{*} for the second three-phase windings.

The current control unit 52 may receive the first current command I_{dq1} ^{*} and the second current command I_{dq2} ^{*} from the mode determination unit 51, and generate a first voltage command V_{dqn1} ^{*} and a second voltage command V_{dqn2} ^{*}.

A current controller 52a in the current control unit 52 may be configured to generate voltage commands V_{dq1} ^{*} and V_{dq2} ^{*} that compensate for a difference between a current command and a motor current based on information about a current flowing through a winding in the motor 30.

A circulating current controller 52b in the current control unit 52 may be configured to generate voltage commands Vₙ₁ ^{*} and Vₙ₂ ^{*} to prevent a circulating current based on information about a circulating current flowing in a winding of the motor 30.

The voltage modulation unit 53 may receive information about the first voltage command, the second voltage command, and the motor angle, and output a first control signal for the first three-phase windings and a second control signal for the second three-phase windings accordingly.

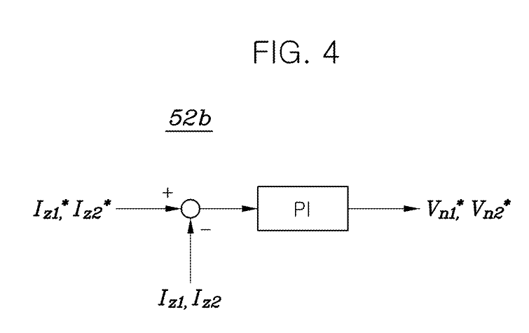

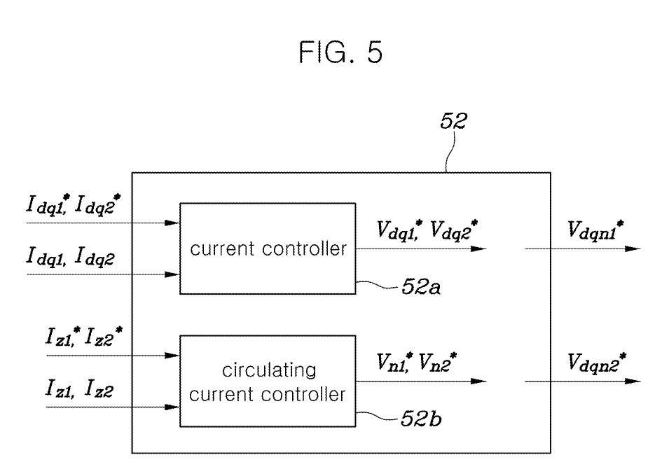

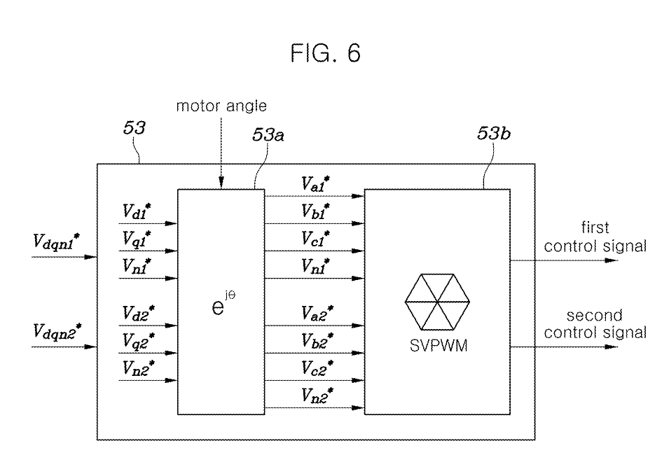

A function of the current control unit 52 will be described in detail with reference to FIG. 4 and FIG. 5, and a function of the voltage modulation unit 53 will be described in detail with reference to FIG. 6.

FIG. 4 is a block diagram illustrating an example of a process in which the circulating current controller of the current control unit is configured to reduce a circulating current according to an exemplary embodiment of the present disclosure.

As in an example of the present disclosure, when the turn ratio of the first three-phase windings is different from the turn ratio of the second three-phase windings, the internal resistance Rₛ₁ by the first three-phase windings and the inductance L_{dq1} of the first three-phase windings may have different values from the internal resistance Rₛ₂ by the second three-phase windings and the inductance L_{dq2} of the second three-phase windings, respectively. As a result, a voltage v_{dqs1} applied to the first three-phase windings may include a different value from a voltage v_{dqs2} applied to the second three-phase windings, and thus a circulating current I_{z} may be generated in the motor, which may reduce motor efficiency.

To prevent a decrease in motor efficiency due to the circulating current I_{z}, the current control unit 52 may include the circulating current controller 52b. The circulating current controller 52b may be configured to generate voltage commands Vₙ₁ ^{*} and Vₙ₂ ^{*} to prevent circulating current through feedback control based on circulating current commands I_{z1} ^{*} and I_{z2} ^{*} and circulating currents I_{z1} and I_{z2} flowing in the respective windings. Since there is ideally no circulating current, the circulating current commands I_{z1} ^{*} and I_{z2} ^{*} may be 0.

Even though FIG. 4 illustrates a case of feedback control through a PI controller (Proportional-Integral controller), this is only an example, and it is obvious to those skilled in the art that other control methods may be used as appropriate.

FIG. 5 is a block diagram illustrating an example of a process in which the current control unit of the controller is configured to generate the first voltage command and the second voltage command according to an exemplary embodiment of the present disclosure.

Referring to FIG. 5, the current controller 52a may be configured to generate voltage commands V_{dq1} ^{*} and V_{dq2} ^{*} to compensate for a difference between the first current and the second current, and the first current command and the second current command based on the first current command and the second current command I_{dq1} ^{*} and I_{dq2} ^{*}, and a first current flowing in the first three-phase windings and a second current flowing in the second three-phase windings I_{dq1} and I_{dq2}. Furthermore, the current control unit 52 may be configured to generate the first voltage command V_{dqn1} ^{*} and the second voltage command V_{dqn2} ^{*} based on the voltage commands V_{dq1} ^{*}, V_{dq2} ^{*}, Vₙ₁ ^{*}, and Vₙ₂ ^{*} generated by the current controller 52a and the circulating current controller 52b.

Although not illustrated in FIG. 5, the current control unit 52 may further include a process of generating a voltage command to offset a specific harmonic voltage based on a current command and a motor angular speed.

FIG. 6 is a block diagram illustrating an example of a process in which the voltage modulation unit of the controller is configured to receive a voltage command and generates a control signal according to an exemplary embodiment of the present disclosure.

Referring to FIG. 6, first, a coordinate transformation unit 53a may transform a first voltage command V_{dqn1} ^{*} and a second voltage command V_{dqn2} ^{*} expressed on a d-q coordinate system into first phase voltage commands Vₐ₁ ^{*}, V_{b1} ^{*}, V_{c1} ^{*}, and Vₙ₁ ^{*} and second phase voltage commands Vₐ₂ ^{*}, V_{b2} ^{*}, V_{c2} ^{*}, and Vₙ₂ ^{*} expressed on an abc coordinate system based on information about the first voltage command V_{dqn1} ^{*}, the second voltage command V_{dqn2} ^{*}, and the motor angle. Furthermore, a pulse width modulation unit 53b may be configured to generate a first control signal and a second control signal using a space vector pulse width modulation (SVPWM) method based on the first phase voltage commands and the second phase voltage commands.

Although not illustrated in FIG. 6, dead time compensation (DTC) may be additionally performed in the present process to compensate for a voltage error due to a dead time to prevent short-circuiting of a switching element.

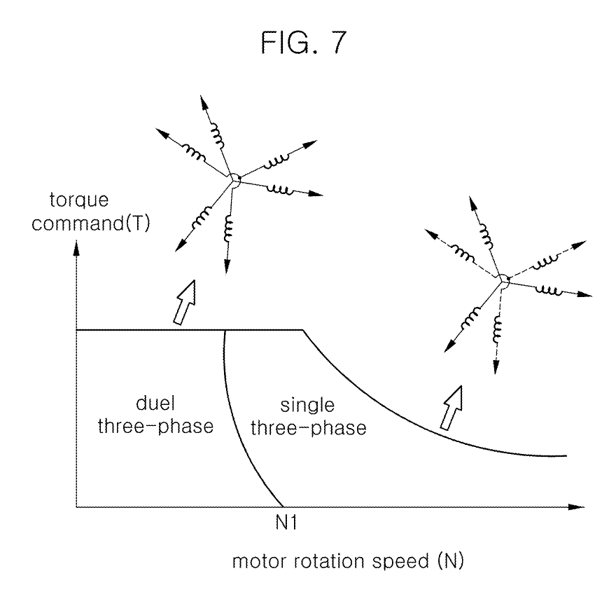

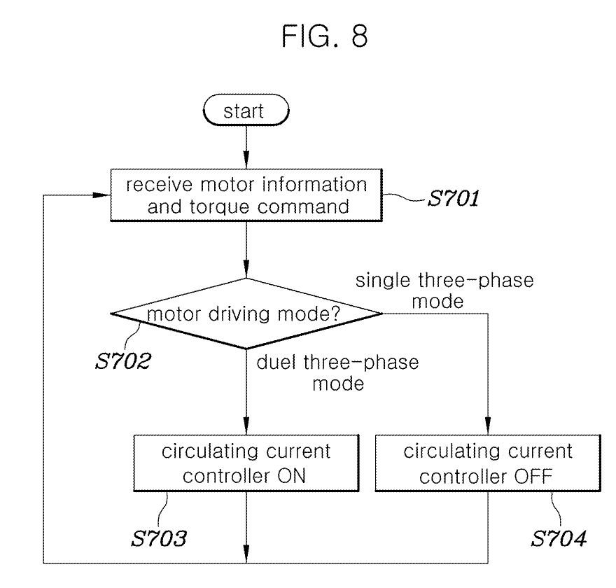

A process in which the controller 50 determines the motor driving mode and generates the control signal according to the determined driving mode has been examined. Hereinafter, a driving strategy of the dual three-phase motor system according to an exemplary embodiment will be described with reference to FIGS. 7 and 8.

FIG. 7 is a graph illustrating an example of the driving strategy of the dual three-phase motor according to the exemplary embodiment of the present disclosure.

In FIG. 7, the inductance L_{dq1} of the first three-phase windings of the motor and the inductance L_{dq2} of the second three-phase windings of the motor are designed to have different values, and it is assumed that the inductance L_{dq2} of the second three-phase windings has a larger value than the inductance L_{dq1} of the first three-phase windings.

Referring to FIG. 7, the controller 50 may drive the motor in the dual three-phase mode that is easy to output torque at low speed since the efficiency problem due to harmonic current does not occur. In the present instance, the motor 30 is driven using all the two inverters 10 and 20 of the motor, and the circulating current controller 52 may be controlled in the ON state to reduce circulating current due to a voltage difference between the two windings.

However, as the motor rotation speed increases, the fifth harmonic and seventh harmonic currents may increase, which may lead to a decrease in motor efficiency. Therefore, in a high-speed section (a section where N1 < N in FIG. 7, wherein the N1 is a predetermined rotation speed and the N is the current rotation speed of the motor), the controller 50 may drive the motor in the single three-phase mode using only one of the first inverter or the second inverter. In the present instance, since the problem of circulating current does not occur, the circulating current controller 52b may be controlled in the OFF state.

Furthermore, since the inductance L_{dq1} of the first three-phase windings and the inductance L_{dq2} of the second three-phase windings have different values, the controller 50 may drive the motor 30 in the first single three-phase mode using the primary-side inverter 10 having lower winding inductance among the two inverters, or in the second single three-phase mode using the secondary-side inverter 20 having higher winding inductance among the two inverters.

Designing the phase difference between the first wiring and the second winding of the dual three-phase motor to be small may be effective in reducing the influence of harmonic current during high-speed operation. However, due to various design constraints, it may be impossible to design the first wiring and the second winding to have the exact same phase. However, as in the example of the present disclosure, when the dual three-phase mode and the single three-phase mode are appropriately operated according to the motor speed, the motor 30 may be effectively controlled not only when the first wiring and the second winding have the same phase but also when there is a phase difference between the two windings.

FIG. 8 is a flowchart illustrating an example of a process in which the controller is configured to control the circulating current controller according to the motor driving mode according to an exemplary embodiment of the present disclosure.

Referring to FIG. 8, the controller 50 may receive motor information such as motor speed and voltage and torque command(S701), and the controller 50 may be configured to determine the driving mode of the motor 30 based on the received information (S702).

When the controller 50 determines to drive the motor 30 in the dual three-phase mode, the controller 50 may be configured for controlling the circulating current controller 52b in the ON state (S703). However, when the controller 50 determines to drive the motor 30 in the single three-phase mode, the controller 50 may be configured for controlling the circulating current controller 52b in the OFF state (S704).

The controller 50 of the dual three-phase motor may be applied to various field of the present disclosures that require both a driving mode requiring high output and a driving mode requiring high efficiency, such as not only electrified vehicles such as electric vehicles and hybrid vehicles, but also aircraft electric propulsion systems or industrial high-output motors.

According to at least an exemplary embodiment of the present disclosure, for the dual three-phase motor in which the inductance of the first three-phase windings and the inductance of the second three-phase windings are different, the motor may be driven in the dual three-phase mode or the single three-phase mode depending on the driving situation, thereby enabling high output control and high efficiency control of the motor. In addition, by providing the circulating current controller, circulating current caused by the voltage difference between the two three-phase windings may be reduced.

Effects that may be obtained from the present disclosure are not limited to the above-mentioned effects, and other effects not mentioned herein will be clearly understood by a person having ordinary skill in the art to which the present disclosure pertains from the above description.

Even though the present disclosure has been illustrated and described above with respect to specific embodiments thereof, it will be apparent to those skilled in the art that the present disclosure may be variously improved and modified without departing from the technical spirit of the present disclosure as defined by the following claims.

What is claimed is:

1. A motor driving apparatus comprising:
a first inverter comprising a plurality of first switching elements and connected to a first three-phase winding of a dual three-phase motor;
a second inverter comprising a plurality of second switching elements and connected to a second three-phase winding of the dual three-phase motor; and
a controller operatively connected to the first inverter and the second inverter and driving the dual three-phase motor in a dual three-phase mode or a single three-phase mode by selectively controlling the first inverter and the second inverter,
wherein the first three-phase winding and the second three-phase winding have different inductances.

2. The motor driving apparatus of claim 1, wherein the first three-phase winding and the second three-phase winding of the dual three-phase motor have different turn ratios.

3. The motor driving apparatus of claim 1, wherein the controller comprises a circulating current controller configured to reduce a circulating current caused by a difference in applied voltage between the first three-phase winding and the second three-phase winding based on the dual three-phase motor being driven in the dual three-phase mode.

4. The motor driving apparatus of claim 3, wherein the controller turns off the circulating current controller based on the dual three-phase motor being driven in the single three-phase mode, and turns on the circulating current controller based on the dual three-phase motor being driven in the dual three-phase mode.

5. The motor driving apparatus of claim 1, wherein the first three-phase winding and the second three-phase winding have the same phase.

6. The motor driving apparatus of claim 1, wherein there is a phase difference between the first three-phase winding and the second three-phase winding.

7. The motor driving apparatus of claim 1, wherein the controller controls the dual three-phase motor in a first single three-phase mode in which the first inverter is turned on to drive the dual three-phase motor, or a second single three-phase mode in which the second inverter is turned on to drive the dual three-phase motor based on the dual three-phase motor being driven in the single three-phase mode.

8. The motor driving apparatus of claim 1, wherein the controller determines a driving mode based on a rotation speed of the dual three-phase motor and a torque command of the dual three-phase motor.

9. An electrified vehicle comprising:
a dual three-phase motor in which a first three-phase winding and a second three-phase winding have different inductances;
a first inverter comprising a plurality of first switching elements and connected to the first three-phase winding of the dual three-phase motor;
a second inverter comprising a plurality of second switching elements and connected to the second three-phase winding of the dual three-phase motor; and
a controller operatively connected to the first inverter and the second inverter and configured to drive the dual three-phase motor in a dual three-phase mode or a single three-phase mode by selectively controlling the first inverter and the second inverter.

10. The electrified vehicle of claim 9, wherein the first three-phase winding and the second three-phase winding of the dual three-phase motor have different turn ratios.

11. The electrified vehicle of claim 9, wherein the controller comprises a circulating current controller configured to reduce a circulating current caused by a difference in applied voltage between the first three-phase winding and the second three-phase winding based on the dual three-phase motor being driven in the dual three-phase mode.

12. The electrified vehicle of claim 11, wherein the controller is further configured to turn off the circulating current controller based on the dual three-phase motor being driven in the single three-phase mode, and turn on the circulating current controller based on the dual three-phase motor being driven in the dual three-phase mode.

13. The electrified vehicle of claim 9, wherein the first three-phase winding and the second three-phase winding have the same phase.

14. The electrified vehicle of claim 9, wherein there is a phase difference between the first three-phase winding and the second three-phase winding.

15. The electrified vehicle of claim 9, wherein the controller controls the dual three-phase motor in a first single three-phase mode in which the first inverter is turned on to drive the dual three-phase motor, or a second single three-phase mode in which the second inverter is turned on to drive the dual three-phase motor based on the dual three-phase motor being driven in the single three-phase mode.

16. The electrified vehicle of claim 9, wherein the controller determines a driving mode based on a rotation speed of the dual three-phase motor and a torque command of the dual three-phase motor.

17. A method for controlling of a motor driving apparatus including a dual three-phase motor, a first inverter including a plurality of first switching elements and connected to a first three-phase winding of the dual three-phase motor, and a second inverter including a plurality of second switching elements and connected to a second three-phase winding of the dual three-phase motor, the method comprising:
driving, by a controller operatively connected to the first inverter and the second inverter, the dual three-phase motor in a dual three-phase mode or a single three-phase mode by selectively controlling the first inverter and the second inverter,
wherein the first three-phase winding and the second three-phase winding have different inductances.

18. The method of claim 17, further comprising:
reducing, by the controller, a circulating current caused by a difference in applied voltage between the first three-phase winding and the second three-phase winding based on the dual three-phase motor being driven in the dual three-phase mode.

19. The method of claim 18, further comprising:
turning off, by the controller including a circulating current controller, the circulating current controller based on the dual three-phase motor being driven in the single three-phase mode; and
turning on, by the controller, the circulating current controller based on the dual three-phase motor being driven in the dual three-phase mode.

20. The method of claim 17, further comprising:
controlling, by the controller, the dual three-phase motor in a first single three-phase mode in which the first inverter is turned on to drive the dual three-phase motor, or a second single three-phase mode in which the second inverter is turned on to drive the dual three-phase motor based on the dual three-phase motor being driven in the single three-phase mode.
